(19) United States
(12) Patent Application Publication
(10) Pub. No.: US 2004/0203568 A1
(43) Pub. Date: Oct. 14, 2004

(54) Computerized warning system interface and method

(76) Inventor: Kenneth P. Kirtland, Murieta, CA (US)

Correspondence Address: Donald W. Meeker, 750 La Playa, # 512, San Francisco, CA, 94121, US

(21) Appl. No.: 10/302,622

(22) Filed: Nov. 22, 2002

Related U.S. Application Data
(63) Continuation-in-part of application No. 10/199,367, filed on Jul. 20, 2002.

(51) Int. Cl. H04M 11/00; H04B 7/00; H04Q 7/20

(52) U.S. Cl. 455/404.1; 455/521

(57) ABSTRACT

The computerized warning system interface is a computer programmed to link between existing systems, such as between a dam monitoring system and a communication network meant to alert individuals in the event of an emergency and/or disaster. The computer interface is programmed to receive signals generated from an existing emergency and/or disaster sensing and/or warning system(s), interpret the type of emergency and/or disaster, based on the signal(s), and activate a communications network to send the appropriate warning message(s) to individuals located in the region affected by the emergency and/or disaster. Warning messages are sent via wireless or wired telephones, pagers, CB radios, internet connections, etc., and/or other communication service providers providing service to land, water, air and space as well as being linked to public warning systems, etc.

### REFERENCES TO RELATED APPLICATIONS

This is a continuation-in-part of patent application Ser. No. 10/199,367, filed Jul. 20, 2002.

### BACKGROUND OF THE INVENTION

1. Field of the Invention

The present invention relates generally to wireless communication systems and more particularly to a warning system utilizing a programmed device which receives information from systems used in sensing and processing environmental conditions and sends out specific warning signals from the programmed device through a telephone network and out to a network of subscribers within a/the wired and/or wireless communication system and to highway warning systems and emergency response vehicles, etc.

2. Description of the Prior Art

Collecting and processing data from remote sensing devices is known. Typically, a remote sensor device remains in a fixed location, senses a particular condition for the given location, and provides the sensed condition to warning devices. For example, in weather monitoring systems, a remote sensing device is designed to monitor temperature, wind, barometric pressure and other weather conditions. The sensed weather conditions are then provided to a processing device, which compiles the data to describe current weather conditions, predict weather changes, and issue warnings when the weather is dangerous in a given area. Other remote sensors may be used along rivers to monitor water levels, along pipelines to monitor the flow rate within the pipes, along geographic faults to monitor seismic activity, within buildings to monitor smoke, adjacent to dams to monitor movement, and other locations subject to dangerous conditions.

In many cases of dangerous conditions, human sightings provide a significant portion of the data or human participation is necessary to send out the warnings. When dangerous conditions are detected, notifying people in harm's way is not always effective. Typically, the public is notified of hazardous conditions by local radio and television broadcasts and neighborhood sirens. But, those who are not currently watching a local television broadcast, listening to a local radio program, or within earshot of the siren, do not receive the warning of the approaching danger.

While some attempts have been made to provide customized warning signals to individuals in danger, these systems are elaborate and very expensive to set up and organize.

U.S. Pat. No. 6,329,904, issued Dec. 11, 2001 to Lamb, provides apparatus and a method for providing weather and other alerts, including an alert device having a receiver, and method are provided for receiving location-specific alert information broadcast via particular telecommunication transmitters operating within a cellular, PCS, or other wireless telecommunications network, thereby allowing delivery of a location-specific message to a user without requiring the input of data representative of the location of the alert device's receiver. The alert device includes a receiver for receiving digital messages in the form of broadcast short messages on a digital control channel, a microcomputer having a monitoring circuit that monitors received digital messages for the presence of an alert code associated with alert messages regarding an alert condition, and a plurality of peripheral devices which produce various tones and flashing lights in response to the alert device's reception of an appropriate alert message.

U.S. Pat. No. 6,104,582, issued Aug. 15, 2000 to Cannon, shows a storm alert automatic system power-down apparatus and processes to automatically power-down a computer system upon determination of the presence, imminence, or forecast of severe weather in the local area. A computer system receives data relating to a weather forecast for a particular local area from a weather service communication server and, based on a determination of the presence, imminence or forecast of severe weather in the local area, initiates an automatic power-down sequence. A delay may be provided to allow the user time to abort the initiation of the automatic power-down sequence. The data may be transmitted in any suitable manner, e.g., over a telephone line through the PSTN, using the Internet, using a paging system, etc. The weather service communication server is provided with the particular local area relating to the computer system. For instance, in the case of a dial-up telephone call to the weather service communication server, call related information such as the telephone exchange number and/or the area code in Caller ID information can be used by the weather service communication server to determine the local area relating to the particular computer system. Thus, a user is provided additional security against damage which may be caused to all or a portion of a computer system due to lightning strikes, downed telephone poles, etc. as a result of severe weather in a local area.

U.S. Pat. No. 6,031,455, issued Feb. 29, 2000 to Grube, claims a method and apparatus for monitoring environmental conditions in a communication system accomplished when a subscriber (22), or group of subscribers, sense an environmental condition or conditions. Upon sensing the particular environmental condition (28) or conditions, the subscriber (or communication device) provides the information about the sensed environmental condition to infrastructure equipment over the wireless communication path. Once the infrastructure equipment receives the information about the sensed environmental condition, it processes it. The processing includes storing the information, averaging the information, predicting future environmental conditions, generating warning signals based on the levels of the environmental condition, and providing feedback to an individual communication device or a group of communication devices. Once information about the sensed environmental condition has been processed, the infrastructure equipment provides at least a selected portion of the processed data to a communication device, based on a subscription of the communication device.

U.S. Pat. No. 5,499,196, issued Mar. 12, 1996 to Pacheco, describes a sensor interface for computer-based notification system for reporting events occurring within a defined area being monitored thereby. The notification system includes a plurality of sensors installed at selected locations within the defined area and a sensor interface coupled to each of the sensors. The sensor interface periodically polls the sensors and stores status information received therefrom. Coupled to the sensor interface is a computer system for receiving and analyzing the stored status data. Upon determining from the status data that an event requiring issuance of a notification has occurred, the computer system issues a series of notifications for which each recipient of a notification receives a selected message regarding the event.

The large infrastructure required to set up the prior art systems as well as the problem of contacting potential subscribers and having them sign up for the warning system requires large amounts of time and capital.

Sensing and warning systems have already been set up in most areas where dangerous conditions exist, such as dams in earthquake areas, forests in drought areas, and other such potentially dangerous sites, etc. Furthermore, the major telephone companies and wireless companies and other telecommunication providers already have an established subscriber base in a given location and internet service providers also have established networks of customers.

What is needed is a simple computer interface, which can be accomplished with simple software capabilities on a personal computer, for interpreting the data associated with the dangerous and/or emergency conditions from the existing sensing and warning systems and transmitting appropriate signals to existing communication systems providing communications to individuals in specific locations.

### SUMMARY OF THE INVENTION

An object of the present invention is to insure the safety of a/the population because it contacts individuals in danger and/or emergency directly through personal communication devices, etc.

Another object of the present invention is to insure further safety by notifying public safety organizations to provide public safety warnings, etc.

One more object of the present invention is to be inexpensive because it uses a computerized interface to connect between pre-existing systems.

An additional object of the present invention is to be set up quickly, since it interfaces with commercial telecommunications infrastructures and detecting systems already in place.

A further object of the present invention is to be safe and secure, using self monitoring technique(s) to insure the system is working.

In brief, in the event of an emergency and/or disaster, such as a dam rupturing from an earthquake, the computerized warning system interface of the present invention comprises a computer programmed to link between existing systems, such as between a dam monitoring system and a communication network.

The computer interface is programmed to receive signals generated from an existing emergency and/or disaster sensing and/or warning system(s), interpret the type of emergency and/or disaster, based on the signal(s), and activate a communications network to send the appropriate warning message(s) to individuals located in the region affected by the emergency and/or disaster. The computer interface would activate a system of group dial-up phone modems, in an existing system and/or provided with the computer interface, to send messages to individuals via wireless or wired telephones, pagers, CB radios, internet connections, etc., and/or other communication service providers providing service to land, water, air and space to notify individuals in the danger area of the impending disaster and/or emergency, etc.

Furthermore, the computer interface may be linked to, and send appropriate messages to, public warning systems including emergency personnel, police, fire fighters, transportation agencies and other governmental and non-governmental agencies, news media, and to motorists in the danger area via programmable highway warning signs, etc.

The computer interface system may consist of a paging station with dial-up modem(s). A control station computer will interface with the paging station via a paging port(s). The control station computer will send pre-determined messages to pagers, via the paging station when activation occurs. These messages can be sent to a single pager, multiple pagers, or all pagers. In addition, the control station's computer will have software capabilities that will allow the user to send ad hoc paging messages. The software will periodically check the operating status of the paging system. The paging station operating software will provide the user with reports that document all paging activities. The system will provide the necessary paging requirements, as specified by local regulations.

The system can page locally or over a wide area and it can work with a variety of types of pagers. It can use its own transmitter or page using a service provider. The system is powerful, yet easy to use. Pages can be sent by multiple operators from separate terminals. Pages can even be sent from any touch tone phone. Furthermore, the system keeps complete records and even has voice mail features.

The system can interface with other systems so that a malfunction which triggers an alarm will cause the system to automatically send a page with a canned message. The system administrator can set up messages which will be sent automatically if the system receives the necessary prompt. For example, if the emergency sensing detection equipment is wired into one of the system's paging ports, an alarm caused by a malfunctioning unit could prompt the system to automatically send a canned message to maintenance personnel. No operator action is required to send an automatic page.

An advantage of the present invention is that it alerts individuals to dangers and/or emergencies directly through personal communication devices.

Another advantage of the present invention is that it notifies public safety organizations to provide public safety warnings.

An additional advantage of the present invention is to be inexpensive.

One more advantage of the present invention is to be set up quickly.

Yet another advantage of the present invention is to be safe and secure using self monitoring techniques, etc.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a schematic view of the warning system interface invention interconnecting a motion and/or movement and/or laser sensing system for a dam with a telecommunications provider's group dial-up modems to send out messages to all prospective individuals;

FIG. 2 is a schematic view of the warning system interface invention of FIG. 1 further comprising an interconnection to organizational and transportation warning systems, etc.

### BEST MODE FOR CARRYING OUT THE INVENTION

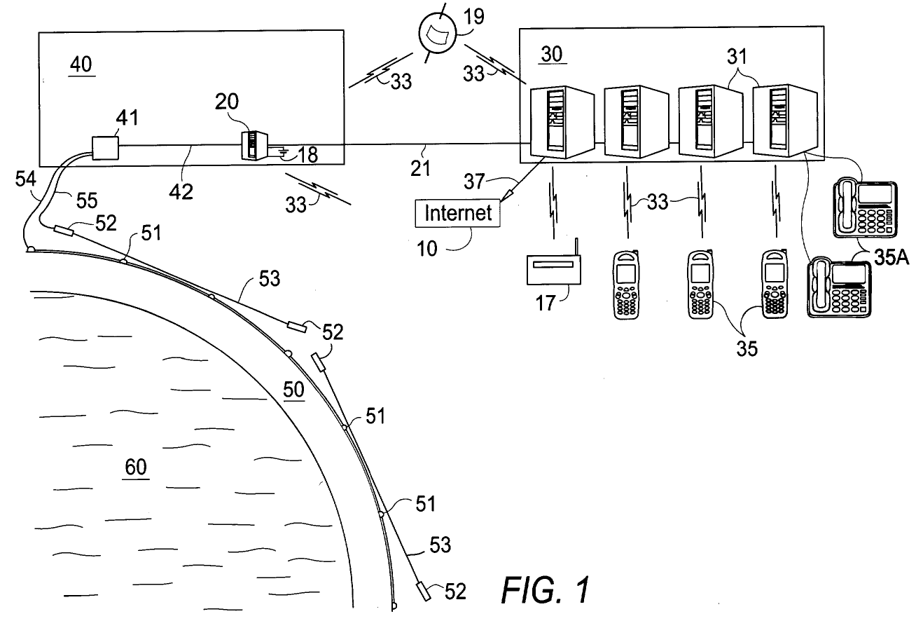

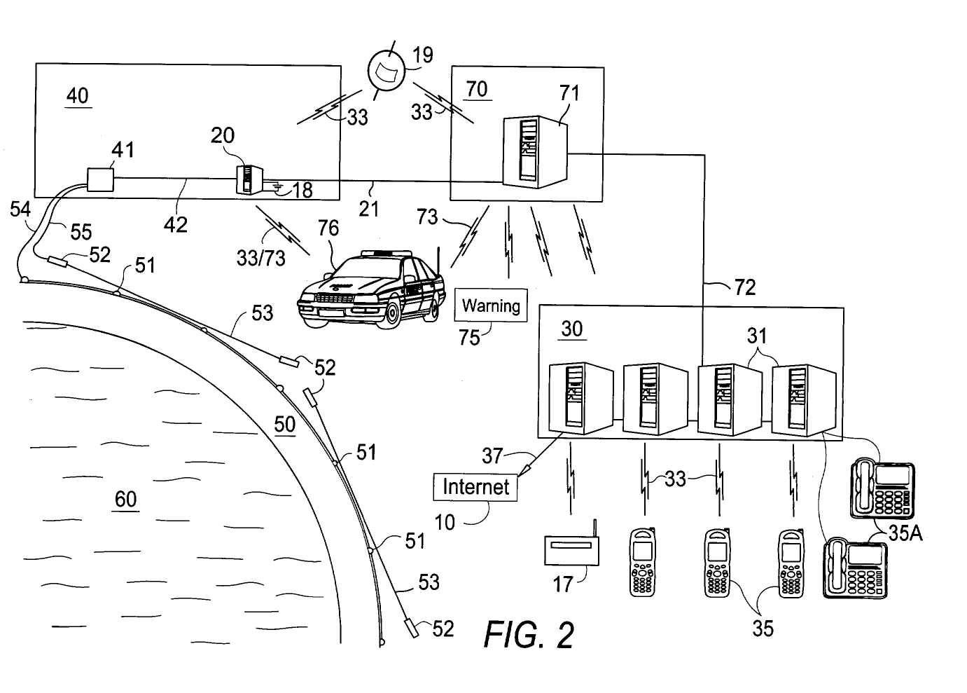

In FIGS. 1-2, a computerized warning system interface is comprised of a programmable computerized interface means 20 for receiving signals via at least one wire 42 from existing disaster and emergency warning systems 41, interpreting the signals and sending appropriate notification of disaster and emergency information to an existing network of individuals having communications devices, such as cell phones 35, wired phones 35A, internet connections 10, CB radios 17, pagers, and other personal communication means, etc.

In FIGS. 1 and 2, the warning system interface is comprised of the programmable computerized interface means 20 with an auxiliary battery 18 as well as conventional power, which computerized interface means 20 may be a personal computer, receiving any of a series of danger and emergency warning signals over a wire 42 from a conventional signaling means 41 in an observation station 40 which normally broadcasts warnings with perhaps lights and sounds and which receives signals over wires 54 and 55 or remotely transmitted from sensors related to potential emergencies and disasters, such as the motion and/or movement detectors 51 on the dam 50 and the laser motion and/or movement sensors 52 using laser beams 53 adjacent to the surface of the dam 50 for sensing and sending warning signals about disasters and impending disasters, such as the weakening or breaking of the dam 50 releasing the water 60.

In FIG. 1 the computerized interface 20 then interprets the signals and sends out specific danger and emergency warning messages responsive to the warning signals over at least one wire 21 or via wireless transmission 33 communication means such as via satellite 19 to a group dial-up modem 31 at a telephone facility 30 or to such a group dial-up modem built into the computerized interface 20 to a large number of individuals simultaneously communicating with a large number of existing personal communications devices, such as a pager, a cellular phone 35 by wireless transmissions 33, a CB radio 17, a wired telephone 35A, an internet connection 10 over the internet communication line(s) 37, and other personal communication means, etc.

In FIG. 2, the programmable computerized interface means 20 sends messages responsive to the warning signals over at least one wire 21 or via wireless transmission 33 communication means such as via satellite 19 to a number of public warning systems including any of the public warning systems 70 with programmed transmitters 71 to send wireless transmissions 73 to organizations and personnel associated with the emergency system including emergency personnel, police 76, fire fighters, transportation agencies and other governmental and non-governmental agencies, news media, and to motorists in the danger area via programmable highway warning signs 75, etc. as well as to a group dial-up modem 31 at a telephone facility 30 or to such a group dial-up modem built into the computerized interface 20 to a large number of individuals simultaneously communicating with a large number of existing personal communications devices, such as a pager, a cellular phone 35 by wireless transmissions 33, a CB radio 17, a wired telephone 35A, an internet connection 10 over the internet communication line(s) 37, and other personal communication means, etc.

In use, a computerized warning interface method comprises receiving signals from existing disaster and emergency warning systems, interpreting the signals, and sending appropriate notification of disaster and emergency information to an existing network of individuals having communications devices. The warning interface method is comprised of the step of programming a programmable computerized interface means 20 for receiving any of a series of danger and emergency warning signals over a wire 42 from a conventional signaling means 41 taking warning input over wires 54 and 55 from conventional and/or new sensing devices, such as motion and/or movement detectors 51 and laser motion and/or movement sensors 52 for a dam 50, for sensing and sending warning signals about disasters and impending disasters. It then interprets the signals and sends out specific danger and emergency warning messages responsive to the warning signals over at least one wire 21 and via wireless transmission means 33/73 to a large number of individuals simultaneously through a group dial-up modem 31 at a communications company 30, through an emergency broadcast system 70, in FIG. 2, with programmed transmissions to emergency organizations and emergency personnel and/or through a built-in group dial-up modem, capable of communicating with a large number of existing personal communications devices, such as a pager, a cellular phone 35 by wireless transmissions 33, a CB radio 17, a wired telephone 35A, an internet connection 10 over the internet communication line(s) 37, and other personal communication means, etc.

In FIG. 2, the method further comprises the step of having the programmable computerized means send messages to a number of public warning systems including any of the public warning systems including emergency personnel, police 76, fire fighters, transportation agencies and other governmental and non-governmental agencies, news media, and to motorists in the danger area via programmable highway warning signs 75, etc.

While a specific application of the invention was shown as a warning system for dam disasters and emergencies, it is understood that the invention could be applied as a programmable computerized warning system interface for any sensing and warning systems including those for tidal waves, forest fires, storms, tornadoes, floods, biohazards, spills, etc., and/or any other systems in place to monitor and signal potential disasters and/or emergencies.

It is understood that the preceding description is given merely by way of illustration and not in limitation of the invention and that various modifications may be made thereto without departing from the spirit of the invention as claimed.

What is claimed is:

1. A computerized warning system interface for receiving signals from existing disaster and emergency warning systems, interpreting the signals and sending appropriate notification of disaster and emergency information to an existing network of individuals having communications devices, the warning system interface comprising:
a programmable computerized means for receiving any of a series of danger and emergency warning signals from a conventional sensing and signaling means for sensing and sending warning signals about disasters and impending disasters, interpreting the signals and sending out specific danger and emergency warning messages responsive to the warning signals to a large number of individuals simultaneously through a group dial-up modem capable of communicating with a large number of existing personal communications devices.

2. The computerized warning system interface of claim 1 wherein the group dial-up modem is a component built into the programmable computerized means.

3. The computerized warning system interface of claim 1 wherein the programmable computerized means communicates with an external existing group dial-up modem.

4. The computerized warning system interface of claim 1 wherein the personal communications devices comprises a device taken from the list of devices including a pager, a cellular phone, a wired telephone, a CB radio, an internet connection, a programmable road sign, and a radio communications device.

5. The computerized warning system interface of claim 1 wherein the programmable computerized means sends messages to a number of public warning systems including any of the public warning systems taken from the list of public warning systems including emergency personnel, police, fire fighters, transportation agencies and other governmental and non-governmental agencies, news media, and to motorists in the danger area via programmable highway warning signs.

6. The computerized warning system interface of claim 1 wherein the conventional sensing and signaling means comprises at least one motion/movement sensor for detecting motion/movement relative to a dam and the conventional means for signaling when motion/movement is detected.

7. The computerized warning system interface of claim 1 wherein the programmable computerized means comprises a personal computer.

8. A computerized warning interface method for receiving signals from existing disaster and emergency warning systems, interpreting the signals and sending appropriate notification of disaster and emergency information to an existing network of individuals having communications devices, the warning interface method comprising:
the step of programming a programmable computerized means for receiving any of a series of danger and emergency warning signals from a conventional sensing and signaling means for sensing and sending warning signals about disasters and impending disasters, interpreting the signals and sending out specific danger and emergency warning messages responsive to the warning signals to a large number of individuals simultaneously through a group dial-up modem capable of communicating with a large number of existing personal communications devices.

9. The computerized warning interface method of claim 8 further comprising the step of building the group dial-up modem as a component of the programmable computerized means.

10. The computerized warning interface method of claim 8 further comprising the step of having the programmable computerized means communicate with an external existing group dial-up modem.

11. The computerized warning interface method of claim 8 wherein the step of communicating with a personal communications device comprises communicating with a device taken from the list of devices including a pager, a cellular phone, a wired telephone, a CB radio, an internet connection, a programmable road sign, and a radio communications device.

12. The computerized warning interface method of claim 8 further comprising the step of having the programmable computerized means send messages to a number of public warning systems including any of the public warning systems taken from the list of public warning systems including emergency personnel, police, fire fighters, transportation agencies and other governmental and non-governmental agencies, news media, and to motorists in the danger area via programmable highway warning signs.

13. The computerized warning interface method of claim 8 wherein the conventional sensing and signaling means comprises at least one motion/movement sensor for detecting motion/movement relative to a dam and the conventional means for signaling when motion/movement is detected.

14. The computerized warning interface method of claim 8 wherein the programmable computerized means comprises a personal computer.
